(19) United States
(12) Patent Application Publication
(10) Pub. No.: US 2015/0220613 A1
(43) Pub. Date: Aug. 6, 2015

(54) RELATIONSHIP ESTIMATION DEVICE AND RELATIONSHIP ESTIMATION METHOD

(71) Applicant: YAHOO JAPAN CORPORATION, Tokyo (JP)

(72) Inventor: Kota TSUBOUCHI, Tokyo (JP)

(21) Appl. No.: 14/487,506

(22) Filed: Sep. 16, 2014

(30) Foreign Application Priority Data
Feb. 6, 2014 (JP) 2014-021167

(51) Int. Cl. G06F 17/30

(52) U.S. Cl. CPC G06F 17/30595; G06F 17/30312

(57) ABSTRACT

Provided are an accompanying detecting unit that detects, on the basis of sensor data acquired by a sensor carried by each of two or more object persons, an accompanying state in which the object persons act together, an active state acquiring unit that acquires, for each object person, multiple pieces of active state data each of which indicates an active state of each of the object persons and that are acquired in accordance with the accompanying state of the object persons detected by the accompanying detecting unit, and an estimating unit that estimates, on the basis of the distances calculated from the multiple active state data on the object persons, the relationship between the object persons.

### CROSS-REFERENCE TO RELATED APPLICATIONS

The present application claims priority to and incorporates by reference the entire contents of Japanese Patent Application No. 2014-021167 filed in Japan on Feb. 6, 2014.

### BACKGROUND OF THE INVENTION

1. Field of the Invention

The embodiments discussed herein are directed to a relationship estimation device and a relationship estimation method.

2. Description of the Related Art

Conventionally, an information processing apparatus that estimates behaviors of a user behaved in the future has been proposed (for example, see Japanese Laid-open Patent Publication No. 2013-206139). The information processing apparatus includes a GPS unit, a user internal state acquiring unit, a history acquiring unit, and a behavior candidate estimating unit.

With the information processing apparatus, the GPS unit acquires location information on a terminal held by a user, the user internal state acquiring unit acquires user state information that indicates the internal state of the user on the basis of an output of a tri-axial accelerometer sensor, and the history acquiring unit associates the location information with the user state information and acquires the information as the behavior history of the user. Then, with the information processing apparatus, the behavior candidate estimating unit estimates, on the basis of the behavior history of the user, multiple kinds of behaviors that will be taken by the user in the future and outputs the estimated result as multiple action candidates.

However, the information processing apparatus disclosed in Japanese Laid-open Patent Publication No. 2013-206139 just only estimates behaviors of a single user. The present inventor has already filed the information processing apparatus that detects the accompanying state of multiple object persons who behave together; however, the information processing apparatus is not able to estimate the relationship of the object persons are accompanied.

### SUMMARY OF THE INVENTION

It is an object of the present invention to at least partially solve the problems in the conventional technology.

According to one aspect of an embodiment, a relationship estimation device includes: an accompanying detecting unit that detects, on the basis of sensor data acquired by a sensor carried by each of two or more object persons, an accompanying state in which the object persons behave together; an active state acquiring unit that acquires, for each object person, multiple pieces of active state data each of which indicates an active state of each of the object persons and that are acquired in accordance with the accompanying state of the object persons detected by the accompanying detecting unit; and an estimating unit that estimates, on the basis of the distances calculated from the multiple pieces of the active state data on the object persons, the relationship between the object persons.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram-illustrating the configuration of a relationship estimation system according to a first or a second embodiment of the present invention;

FIG. 2 is a block diagram illustrating the configuration of a relationship estimation device according to the first embodiment of the present invention;

FIG. 3 is a block diagram illustrating the hardware configuration of the relationship estimation device according to the first embodiment of the present invention;

FIG. 4 is a block diagram illustrating the configuration of an accompanying detecting unit according to the first embodiment of the present invention;

FIG. 5 is a graph illustrating the waveform of step count data acquired from a pedometer according to the first embodiment of the present invention;

FIG. 6 is a block diagram illustrating the configuration of a compromise level calculating unit according to the first embodiment of the present invention;

FIG. 7 is a graph illustrating an example of compromise level calculation performed by using an unsupervised machine learning method according to the first embodiment of the present invention;

FIG. 8 is a graph illustrating an example of compromise level calculation performed by using a supervised machine learning method according to the first embodiment of the present invention;

FIG. 9 is a flowchart illustrating the flow of a relationship estimation process according to the first embodiment of the present invention;

FIG. 10 is a graph illustrating the relationship between object persons on the basis of the estimation result according to the first embodiment of the present invention;

FIG. 11 is a block diagram illustrating the configuration of a relationship estimation device according to the second embodiment of the present invention; and

FIG. 12 is a graph illustrating the relationship between object persons on the basis of the estimation result according to the second embodiment of the present invention.

### DETAILED DESCRIPTION OF THE PREFERRED EMBODIMENTS

In the following, embodiments of the present invention will be described.

Outline

A relationship estimation device according to the embodiments detects, by using sensor data obtained by a sensor, such as a pedometer, carried by an object person that is targeted for the relationship-estimation, whether specific object persons behave together, i.e., whether specific object persons are accompanied; acquires, for each object person, multiple pieces of active state data each of which indicates an active state of each of the object persons and that are acquired in accordance with the accompanying state of the object persons; and estimates, on the basis of the distance calculated from the multiple pieces of the active state data on the object persons, the relationship between the object persons related to an organizational connection or a personal connection.

### DEFINITION OF TERMS

Before a description of a relationship estimation system according to the embodiment is described, some of the terms used in the relationship estimation system will be described first.

In the embodiment, a sensor is a device that detects an active state of an object person. In the embodiment, a pedometer carried by an object person will be described as an example of the sensor; however, the sensor is not limited to the pedometer but an activity meter may also be used. For the sensor used in the embodiment, a wireless communication device, such as Bluetooth (registered trademark), Wi-Fi (registered trademark), or infrared, is preferably equipped. The pedometer mentioned here is a device that detects the acceleration by an acceleration sensor and measures a step count; however, the pedometer is not limited thereto. For example, a device that detects the acceleration by using a pendulum and measures a step count on the basis of the detection result may also be used.

Furthermore, examples of the sensor in this embodiment include a mobile terminal equipped with a GPS function of acquiring location information, an acceleration sensor that detects the acceleration, a gyro sensor that detects an angular velocity, a magnetic field sensor that detects the direction of a magnetic field, a temperature sensor that detects a temperature, a humidity sensor that detects humidity, a pressure sensor that detects air pressure, a timer that detects time information, an accelerometer, a calorie consumption calculator, or the like. Furthermore, multiple combinations of these sensors may also be used.

The “sensor data” obtained from the sensor is data that indicates the amount of activity of an object person at different times obtained by the sensor. For example, if a pedometer is used as the sensor, it is possible to use step count information per unit time, for example, a step count per minute, obtained from the pedometer, as the sensor data, i.e., step count data. However, the sensor data is not limited thereto. If an acceleration sensor is used as the sensor, acceleration data may also be used or step count information, consumption calorie, or the like of an object person calculated on the basis of the acceleration data may also be used. Furthermore, recorded data, such as a diary in which date and time information and destination information are recorded, may also be read as the sensor data.

The “step count data” mentioned in the embodiment is obtained from a combination of, for example, step count information that indicates a step count per minute obtained from a pedometer and time information that indicates the time point at which the step count information is obtained. However, the “step count data” is not limited thereto. It may be a combination of step count information that indicates a step count per second or per hour obtained from a pedometer and time information that indicates the time point at which the step count information is obtained. For example, the step count data that is obtained by a pedometer in one minute from 8:00:00 to 8:01:00 is a combination of the time information indicating 8:01:00 and the step count information indicating step count of 90 steps per minute. Furthermore, identification information for identifying an object person who carries a pedometer is included in the step count data.

Overall Configuration of Relationship Estimation System According to First Embodiment

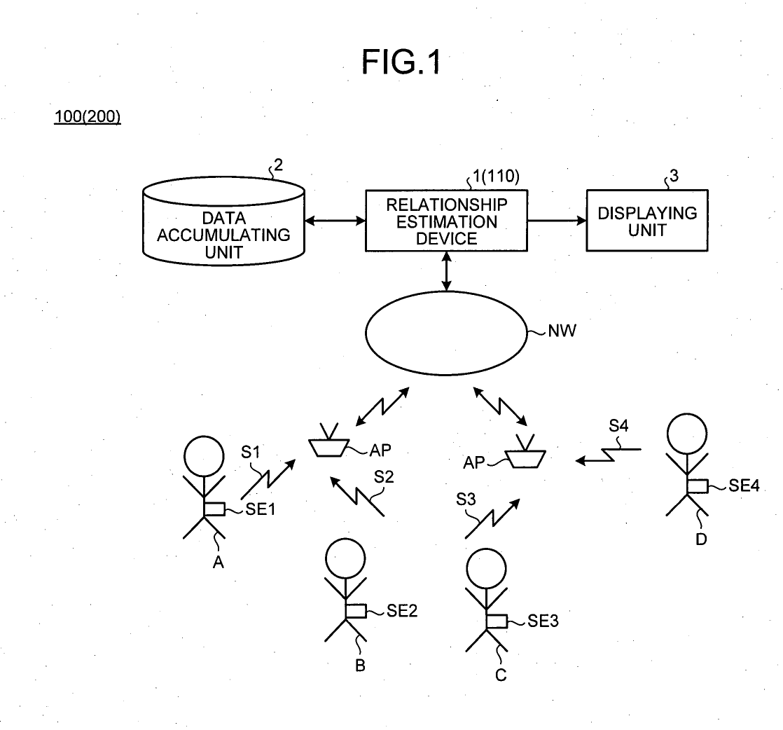

FIG. 1 illustrates the overall configuration of a relationship estimation system 100. The relationship estimation system 100 includes sensors (pedometer) SE1 to SE4 carried by multiple object persons A to D, respectively, targeted for relationship estimation; a relationship estimation device 1 that estimates the relationship between the object persons A to D on the basis of sensor data (step count data) S1 to S4 obtained from the sensors SE1 to SE4, respectively, via a network NW; a data accumulating unit 2 that accumulates the sensor data (step count data.) S1 to S4; and a displaying unit 3 that displays the relationship estimation result obtained by the relationship estimation device 1.

If the accompanying state of three or four persons out of the object persons A, B, C, and D are detected, the relationship between these three or four object persons can be estimated; however, for convenience of description, in the following, a description will be given of a case in which the relationship between the two object persons A and B is estimated.

These multiple object persons A to D individually behaves and their behaviors are detected as the step count data S1 to S4 by the sensors SE1 to SE4, respectively. Accordingly, the pieces of the step count data S1 to S4 obtained from the sensors SE1 to SE4 in accordance with the behaviors of the object persons A to D, respectively, are sent to the relationship estimation device 1 from access points AP via the network NW.

The relationship estimation device 1 sequentially accumulates, in the data accumulating unit 2, the pieces of the step count data S1 to S4 related to the object persons A to D sent from the sensors SE1 to SE4, respectively. Then, by using the step count data S1 and S2 from among the multiple pieces of the step count data S1 to S4 accumulated in the data accumulating unit 2, the relationship estimation device 1 estimates the relationship between the object persons A and B and displays the estimated relationship estimation result on the displaying unit 3 in a visually and intuitively easy-to-understand manner.

Configuration of Relationship Estimation Device According to First Embodiment

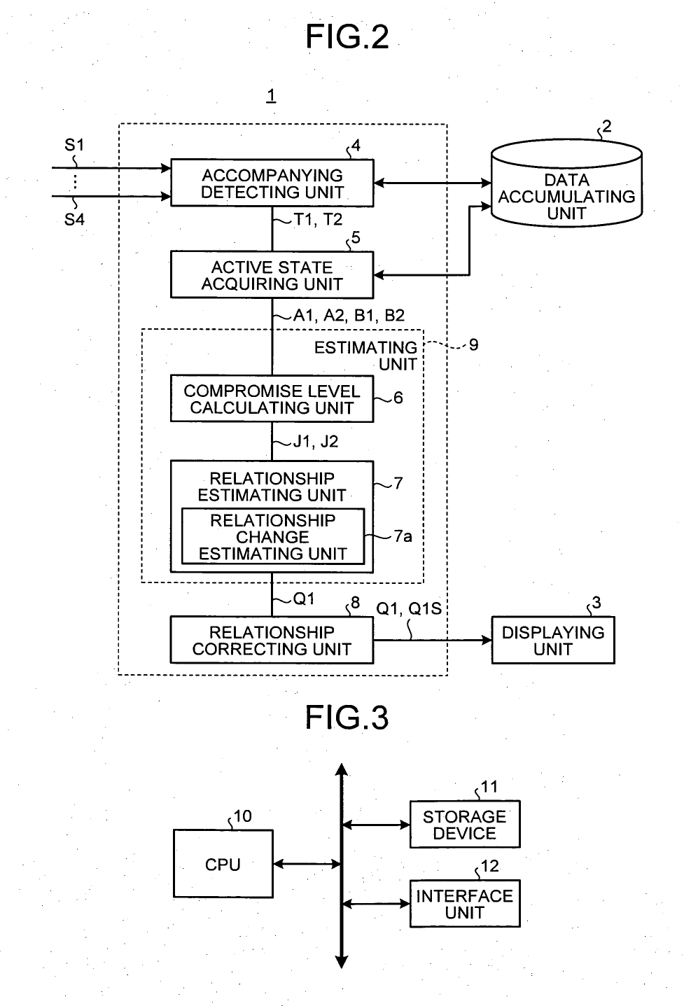

As illustrated in FIG. 2, the relationship estimation device 1 includes an estimating unit 9 constituted by an accompanying detecting unit 4 that detects, on the basis of the step count data S1 to S4, whether the multiple object persons A to D are accompanied; an active state acquiring unit 5 that acquires an active state of the object persons A to D when they are accompanied and an active state of the object persons A to D at the normal time that is other than the time of the accompanying; a compromise level calculating unit 6 that calculates a compromise level that is used as a first index obtained on the basis of the difference between the active state of the object persons A to D when they are accompanied and the active state the object persons A to D at the normal time; and a relationship estimating unit 7 that estimates the relationship between the object persons on the basis of the compromise level for each of the object persons A to D. The relationship estimation device 1 also includes a relationship correcting unit 8 that corrects the relationship between the object persons A to D.

As illustrated in FIG. 3, the relationship estimation device 1 can be implemented by installing a program (software) in a computer (hardware) constituted by a central processing unit (CPU). 10, a storage device 11, such as a memory or a hard disk, and an interface unit 12. Various hardware resources and the program in the computer cooperate with each other, whereby implementing each of the functions performed by each of the units 4 to 8 in the relationship estimation device 1. Furthermore, the program may also be provided by being stored in a computer readable recording medium or the storage device 11 or, alternatively, may also be provided via a telecommunication line.

Accompanying Detecting Unit

The accompanying detecting unit 4 is a functioning unit that detects the “accompanying state” in which each of the multiple object persons A to D conceivably behaves with the other object persons.

Specifically, from the sensor data (in the embodiment, step count data S1 to S4) obtained from each of the multiple object persons A to D, respectively, the accompanying detecting unit 4 determines, on the basis of arbitrary two object persons (for example, the step count data S1 and S2 related to the object persons A and B, respectively), whether these two object persons were in the accompanying state. If the accompanying detecting unit 4 detects that these two object persons were in the accompanying state, the accompanying detecting unit 4 outputs, to the active state acquiring unit 5, an accompanying determination result T1 indicating that these two object persons were in the accompanying state. In contrast, if the accompanying detecting unit 4 detects that these two object persons were not in the accompanying state, the accompanying detecting unit 4 outputs, to the active state acquiring unit 5, a non-accompanying determination result T2 indicating that these two object persons were not in the accompanying state. In the following, for convenience of description, a description will be given of a case in which the accompanying detecting unit 4 detects, on the basis of the step count data S1 and S2 on the object persons A and B, respectively, whether the object persons A and B, who are focused as the detection-target of the accompanying, were in the accompanying state indicating that the object persons A and B behaves together at the same time period.

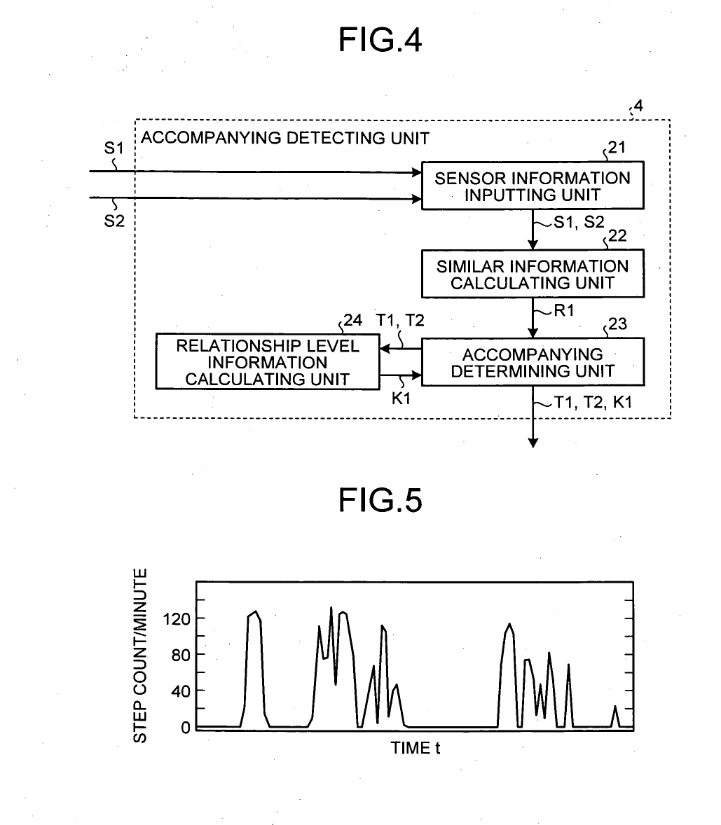

In the following, the specific functional configuration of the accompanying detecting unit 4 will be described with reference to FIG. 4. The accompanying detecting unit 4 includes a sensor information inputting unit 21, a similar information calculating unit 22, an accompanying determining unit 23, and a relationship level information calculating unit 24.

Sensor Information Inputting Unit

The sensor information inputting unit 21 sequentially receives the step count data S1 to S4 sent from the sensors SE1 to SE4 carried by the object persons A to D, respectively, via the access points AP and the network NW and then inputs the received data to the similar information calculating unit 22, which will be described later. When focusing on the object persons A and B, because the step count data S1 and S2 is step count information on the object persons A and B per, for example, minute, the step count data S1 and S2 that has the same time information is input to the sensor information inputting unit 21 from the sensors SE1 and SE2 at an interval of one minute. Furthermore, as illustrated in FIG. 4, the step count-data S1 and S2 can be represented by a waveform that indicates a change in the step count of each of the object persons A and B associated with a time t per minute.

Similar Information Calculating Unit

The similar information calculating unit 22 calculates similar information R1 that indicates the similarity of the behaviors (a walk in this case) of the object persons A and B on the basis of the step count data S1 and S2, having the same time information, on the object persons A and B supplied from the sensor information inputting unit 21. For example, a greater value is used for the similar information R1 as the degree of a matching of the step count data S1 and S2 is increased when the step count data S1 and S2 on the object persons A and B, respectively, are compared.

Accordingly, it is conceivable that, when the similar information R1 is calculated from the step count data S1 and S2 at a predetermined time interval and if the similar information R1 is large, there is a high possibility that the object person A and the object person B behaved together during that time period and, the similar information R1 is small, there is a high possibility that the object person A and the object person B independently behaved. The similar information calculating unit 22 outputs the similar information R1 to the accompanying determining unit 23. Because the method of calculating the similar information R1 on the basis of the two pieces of data has already been-known, a description of the method in detail will be omitted here.

Accompanying Determining Unit

The accompanying determining unit 23 determines, on the basis of whether the similar information R1 supplied from the similar information calculating unit 22 exceeds a predetermined threshold, whether the object persons A and B were in the accompanying state during the period of the time targeted for the calculation of the similar information R1.

If the similar information R1 exceeds the threshold, the accompanying determining unit 23 determines that the object persons A and B were accompanied in the time period that is targeted for the calculation of the similar information R1. In contrast, if the similar information R1 does not exceeds the threshold, the accompanying determining unit 23 determines that the object persons A and B were not accompanied in the time period that is targeted for the calculation of the similar information R1.

The determination result obtained in this way is associated with the time information in the step count-data S1 and S2 on the object persons A and B belonging to the time period and is output, to the data accumulating unit 2 and the active state acquiring unit 5 that are arranged downstream, the associated determination result as an accompanying determination result T1, which indicates that the object persons A and B were accompanied at the time point at which the time information is obtained, or a non-accompanying determination result T2, which indicates that the object persons A and B were not accompanied at the time point at which time information is obtained.

Accordingly, if the accompanying determining unit 23 continuously obtains, every minute, the accompanying determination result T1, in which the time information obtained at 8:10:00 is included, starting from the accompanying determination result T1, in which the time information obtained at 8:01:00 is included, the accompanying determining unit 23 can determine that the object persons A and B were accompanied for 10 minutes between 8:00:00 and 8:10:00. In this way, the accompanying determining unit 23 can also determine whether the object persons A and B were accompanied and specify the accompanying time.

The threshold may be determined by referring to the step count data S1 and S2 obtained when the object persons A and B were actually are accompanied in the past by using a manual or statistical process; however, the threshold may also appropriately be set by a designer or an administrator of the relationship estimation device 1.

Relationship Level Information Calculating Unit>

The relationship level information calculating unit 24 is connected to the accompanying determining unit 23; calculates, on the basis of the accompanying determination result T1 and the non-accompanying determination result T2 between the object persons A and B, relationship intensity information K1 that indicates the degree of connection between the object persons A and B; stores the relationship intensity information K1 in an internal storing unit; and outputs the relationship intensity information K1 to the active state acquiring unit 5, which is arranged downstream, via the accompanying determining unit 23.

The relationship intensity information K1 mentioned here is information that indicates the degree of connection, i.e., the degree of a link, between the object persons A and B when the object persons A and B carrying the sensors SE1 and SE2, respectively, are determined to be in the accompanying state on the basis of the accompanying determination result T1. The relationship intensity information K1 may be information converted into numbers or information that is indicated, in stages, “strong”, “weak”, or the like.

If the relationship intensity information K1 is represented as numerical rating information, a larger value is used as the longer time period for which the object persons A and B were determined to be in the accompanying state on the basis of the accompanying determination result T1 obtained by the accompanying determining unit 23. However, the relationship intensity information K1 is not limited thereto. For example, a larger value may also be used as the greater number of times of the accompanying of the object persons A and B who are determined to be in the accompanying state on the basis of the accompanying determination result T1 obtained by the accompanying determining unit 23.

As described above, the accompanying detecting unit 4 detects whether two arbitrary persons out of the multiple object persons A to D were in the accompanying state and then outputs the result to the active state acquiring unit 5, which will be described later. Consequently, by detecting whether two out of the object persons A to D were accompanied, it is possible to specify the time zone at which each of the object persons A to D accompanied the other object persons A to D other than the subject person or it is possible to specify an accompanied object person.

Active State Acquiring Unit

The active state acquiring unit 5 illustrated in FIG. 2 is a functioning unit that acquires, for each focused object person, on the basis of the accompanying determination result T1 obtained by the accompanying detecting unit 4, i.e., on the basis of the time zone at which each of the object persons accompanied the other object persons other than the subject person or the accompanied object person, sensor data that indicates an active state that is obtained when an arbitrary object person was in an accompanying state with the other specific object person (hereinafter, this state is referred to as an “accompanying time active state”) and sensor data that indicates an active state that is obtained when the arbitrary object person is not in the accompanying state with the other specific object person (hereinafter, referred to as a “normal time active state”).

The “active state” mentioned here includes a movement of an object person, a physical state, such as a blood pressure, a heart rate, or the like, a taste, and the like and can be aware by information that is acquired from an object person or the sensor attached to the belongings of the object person.

In the embodiment, a description will be given of a case in which the step count data described above is used as the sensor data that indicates the active state of an object person; however, the sensor data indicating the active state is not limited to the step count data. For example, path data related to the path along which an object person went or acceleration data may also be used. The path data or the acceleration data can be acquired by global positioning system (GPS) function performed by a mobile information device, such as a smart phone, a wearable terminal, and the like, or an acceleration sensor carried by an object person.

Furthermore, by using the sensor attached to the wearable terminal, an amount of nods of an object person, a swing of a body, the distance between the object persons, the time taken for a meal, an amount of conversation, or the like as the information that indicates the active state. Furthermore, by an object person using forks equipped with a sensor, it is possible to acquire, as the information that indicates the active state, for example, seasoning information as food preferences (information whether the food has a high salt content or low salt content).

In the embodiment, the reason for acquiring both the sensor data that indicates the accompanying time active state and the sensor data that indicates the normal time active state by using the active state acquiring unit 5 is it is assumed that, when an object person accompanies the other person, the object person indicates an active state that is different from an active state indicated at the normal time, i.e., when the object person is being alone. The difference between the accompanying time active state and the normal time active state is indicated by the compromise level calculating unit 6 in the estimating unit 9, which will be described later, as the “compromise level” that corresponds to a first index.

The “normal time active state” may also be used as the active state that is obtained when, for an object person out of two focused object persons, the object person is not in the accompanying state with the other object person. However, in this case, the sensor data that is obtained when the object person is in the accompanying state with the other object persons other than the two focused object persons is also used as the sensor data that indicates the “normal time active state”, i.e., normal time active state data, as long as the object person is not in the accompanying state with the other object person.

If the effect of the object persons other than the two focused object persons is needed to be eliminated, the active state that is obtained when the object person is not in the accompanying state with the other object persons, i.e., the active state that is obtained when the object person is assumed to be alone, may also be defined as the “normal time active state” and then the sensor data that is obtained when the object person is in the accompanying state with one of the object persons may also be excluded from the “normal time active state data”.

In the following, an operation of the active state acquiring unit 5 will be described in a case in which, as an example, the object persons A and B are focused. In the embodiment, a description will be given with the assumption that the state in which the focused object person A or B does not accompany the other object persons including the other object persons C and D is defined as the “normal active state”.

Acquisition of Data that Indicates Accompanying Time Active State

First, for the object person A used as one of the object persons, on the basis of the accompanying determination result T1 indicating that the object person A accompanied the other object person B, the active state acquiring unit 5 acquires, from the data accumulating unit 2, the step count data S1 on the object person A that is associated with the time information in the accompanying determination result T1 and then outputs the step count data S1 to the compromise level calculating unit 6, which will be described later.

Accordingly, the step count data S1 on the object person A obtained at this point is the step count information on the object person A per unit time (per minute) when the object persons A and B were accompanied. In the embodiment, the step count data S1 is used as the sensor data that indicates the accompanying time active state of the object person A when the object person A accompanies the object person B (hereinafter, referred to as “accompanying time active state data A1”).

Acquisition of Data that Indicates Normal Time Active State

Furthermore, on the basis of the accompanying determination result (or the non-accompanying determination result) related to the object person A, the active state acquiring unit 5 acquires, from the data accumulating unit 2, step count data S0 that is obtained when the object person A does not accompany other object persons and then outputs the step count data S0 to the compromise level calculating unit 6, which will be described later. The step count data S0 on the object person A is step count information on the object person A per unit time (per minute) when the object person A acts alone. In the embodiment, it is assumed that the step count data S0 is used as the sensor data that indicates the normal time active state of the object person A when the object person A acts alone (hereinafter, referred to as “normal time active state data A2”).

In this way, the active state acquiring unit 5 acquires, from the data accumulating unit 2, the step count data S1 and S0 that indicates the accompanying time active state that is obtained when the object person A accompanies the object person B and the normal time active state that is obtained when the object person A is being alone, respectively, and then outputs the acquired data to the compromise level calculating unit 6.

Then, for the object person B, on the basis of the accompanying determination result T1 (or the non-accompanying determination result T2) related to the object person B, the active state acquiring unit 5 also acquires, from the data accumulating unit 2, the sensor data that indicates the accompanying time active state that is obtained when the object person B accompanies the object person A (hereinafter, referred to as “accompanying time active state data B1”) and sensor data that indicates the normal time active state of the object person B (hereinafter, referred to as “normal time active state data B2”), and then outputs the acquired data to the compromise level calculating unit 6.

Compromise Level Calculating Unit

For the two focused object persons A and B, the compromise level calculating unit 6 in the estimating unit 9 obtains, as the “compromise level”, from the sensor data that indicates an active state of each of the two object persons A and B input from the active state acquiring unit 5 described above, the distance (an amount of change) between the accompanying time active state that is obtained when both the object persons A and B are accompanied and the normal time active state of each of the object persons A and B.

For the “compromise level” described above between a pair of object persons (for example, the object persons A and B), it is assumed that the compromise level of the object person A indicates, for example, the degree of behavior of the object person A who behaves according to the object person B when the object person A accompanies the object person B, i.e., the degree of compromise made by the object person A with respect to the object person B, and it is assumed that the compromise level of the object person B indicates, for example, the degree of behavior of the object person B who behaves according to the object person A when the object person B accompanies the object person A, i.e., the degree of compromise made by the object person B with respect to the object person A.

In this way, in the space defined by the parameter that indicates, for example, the active state, the compromise level can be represented by the distance between the subspace defined by the sensor data that indicates the accompanying time active state and the subspace defined by the sensor data that indicates the normal time active state or can be represented by the difference (the distance) between the representative value of the sensor data that indicates the accompanying time active state and the representative value of the sensor data that indicates the normal time active state.

Specifically, when focusing on the object persons A and B, the compromise level calculating unit 6 calculates the difference between the representative value of the average value or the like of the accompanying time active state data A1 on the object person A with respect to the object person B and the representative value of the average value or the like of the normal time active state data A2 as a compromise level J1 of the object person A with respect to the object person B and then outputs the calculation result to the relationship estimating unit 7. Furthermore, the compromise level calculating unit 6 calculates the difference between the representative value of the average value or the like of the accompanying time active state data B1 on the object person B and the representative value of the average value or the like of the normal time active state data B2 as the compromise level J2 of the object person B and then outputs the calculation result to the relationship estimating unit 7.

For example, as the normal time active state data A2 on the object person A, when the average value of the step count data S0 is “80 steps/minute”, if the average value of the step count data S1 is “90 steps/minute” as the accompanying time active state data A1, a change in “10 steps/minute” occurs between the normal time active state of the object person A and the accompanying time active state of the object person A with respect to the object person B. This state can be assumed that the object person A compromises with the object person B by “10 steps/minute” when the object person A accompanies the object person B. Accordingly, the compromise level J1 of the object person A with respect to the object person B can be defined as “10 steps/minute”.

Furthermore, when the average value of the normal time active state data B2 (step count data) of the object person B is “120 steps/minute”, if the average value of the accompanying time active state data B1 (step count data) is. “90 steps/minute”, a change in “30 steps/minute” occurs between the normal time active state of the object person B and the accompanying time active state of the object person B with respect to the object person A. This state can be assumed that the object person B compromises with the object person A by “30 steps/minute” when the object person B accompanies the object person A. Accordingly, the compromise level J2 of the object person B at this point can be defined as “30 steps/minute”.

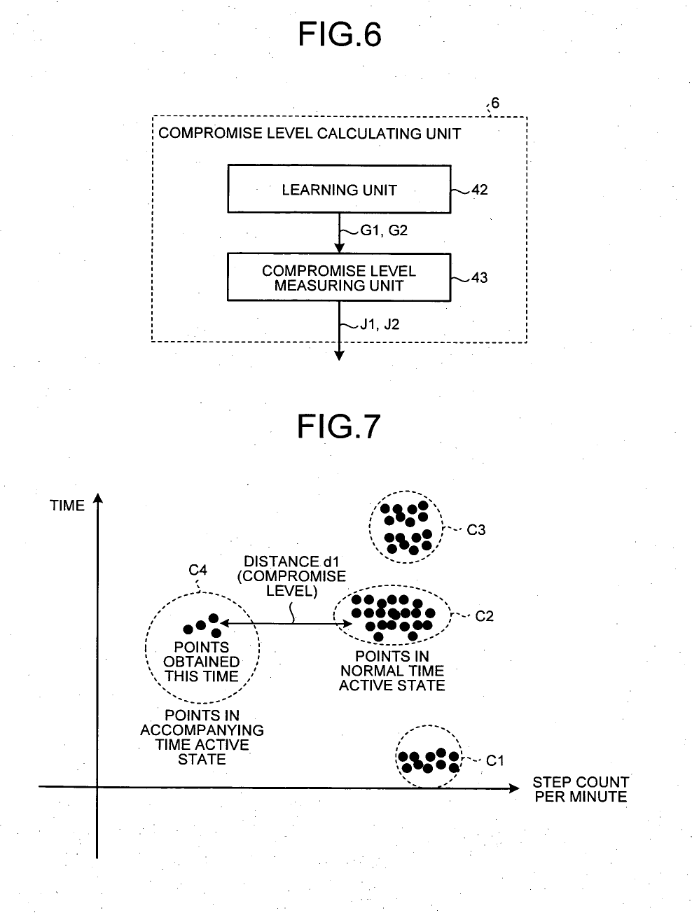

In order to implement the function of calculating the compromise level described above, the compromise level calculating unit 6 includes, as illustrated in FIG. 6, a learning unit 42 and a compromise level measuring unit 43. The learning unit 42 used here is a functioning unit that determines, on the basis of the sensor data related to the active state of each of the object persons, whether an active state is the accompanying time active state of an object person or the normal time active state of the object person.

Furthermore, the compromise level measuring unit 43 is a functioning unit that calculates, as a compromise level and on the basis of the result of learning obtained by the learning unit 42, the distance between the active state obtained from the normal time active state and the active state obtained from the accompanying time active state. In the embodiment, the step count data is used as the sensor data. Specifically, a description will be given with the assumption that the accompanying time active state data A1 and the normal time active state data A2 are used for the object person A, whereas the accompanying time active state data B1 and the normal time active state data B2 are used for the object person B.

An example of a learning method used in the learning unit 42 includes an unsupervised machine learning method, such as a local outlier factor (LOF), or a supervised machine learning method.

Example of Learning by Using Unsupervised Machine Learning Method and Calculation of Compromise Level

In the following, a description will be given of an example method of obtaining, by using the unsupervised machine learning method, the compromise levels J1 and J2 of the object persons A and B in the relationship between the object persons A and B, respectively. As illustrated in FIG. 7, the accompanying time active state data A1 and the normal time active state data A2 on the object person A with respect to the object person B that are input from the active state acquiring unit 5 are represented by points on the two-dimensional coordinates in which a “step count per minute” and the “time” are used as the parameters.

When the compromise level J1 of the object person A in the relationship between the object persons A and B is obtained by using the unsupervised machine learning method, first, the learning unit 42 groups, by time, the accompanying time active state data A1 and the normal time active state data A2 on the object person A with respect to the object person B and then classifies them into clusters C1, C2, C3, and C4.

For example, it is assumed that the cluster C1 is a set of step count data at the time when the object person A starts of working hours, the cluster C2 is a set of step-count data at the break time of the object person A, and the cluster C3 is a set of step count data at the time when the object person A returns home from work. Because the step counts per minute of these clusters are substantially the same, it can be found that the sensor data on the clusters C1 to C3 is the normal time active state data A2.

In contrast, similarly to the cluster C2, the sensor data on the cluster C4 is a set of step count data at the break time of the object person A; however, unlike the cluster C2 indicating the normal time active state, it is assumed that the cluster C4 is a set of step count data in which a step count per minute has a value different from the values of the clusters C1 to C3. Accordingly, it can be found that the sensor data on the cluster C4 is accompanying time active state data A1.

In this way, the learning unit 42 determines whether the clusters C1, C2, C3, and C4, which are obtained by classifying the accompanying time active state data A1 and the normal time active state data A2 on the object person A with respect to the object person B, are the accompanying time active state data or the normal time active state data and then outputs the result as the learning result G1 to the compromise level measuring unit 43.

The compromise level measuring unit 43 calculates the distance between the representative value of the normal time active state data of one or all of the clusters C1 to C3 and the representative value of the accompanying time active state data of the cluster C4 as the compromise level J1 of the object person A with respect to the object person B.

In the embodiment, the compromise level measuring unit 43 calculates, as the compromise level J1 of the object person A with respect to the object person B and on the basis of the learning result G1, the Euclidean distance D1 between the center of gravity of the cluster C2 that indicates the normal time active state obtained at the break time and the center of gravity of the cluster C4 that indicates the accompanying time active state and then outputs the calculation result to the relationship estimating unit 7. As described above, the compromise level calculating unit 6 constituted by the learning unit 42 and the compromise level measuring unit 43 calculates the compromise level J1 of the object person A with respect to the object person B and outputs the calculation result to the relationship estimating unit 7, which will be described later.

Furthermore, similarly to the above, the compromise level calculating unit 6 calculates, on the basis of the accompanying time active state data. B1 and the normal time active state data B2 of the object person B with respect to the object person A, the compromise level J2 of the object person B with respect to the object person A and then outputs the calculation result to the relationship estimating unit 7.

Example of Learning by Using Supervised Machine Learning Method and Calculation of Compromise Level

In contrast, instead of using the unsupervised machine learning method, it is possible to obtain the compromise levels of the object persons A and B in the relationship between the object persons A and B by using the supervised machine learning method.

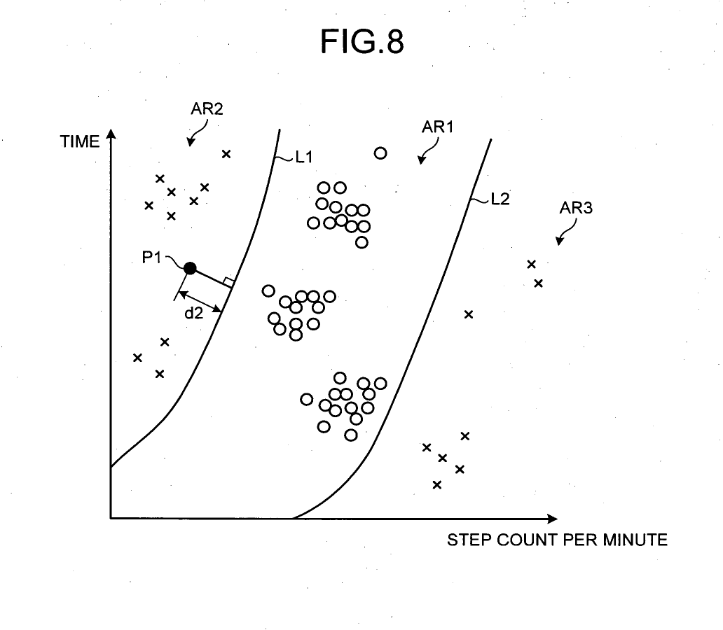

In the supervised machine learning method, as illustrated in FIG. 8, the accompanying time active state data A1 and the normal time active state data A2 that are input from the active state acquiring unit 5 and that are related to the object person A with respect to the object person B are represented by points on the two-dimensional coordinates in which a “step count per minute” and the “time” are used as the parameters. At this point, unlike the unsupervised machine learning method described above, a label indicating a difference between the “accompanying time active state” and the “normal time active state” is previously attached to each piece of the data.

In FIG. 8, the accompanying time active state data A1 is represented by the label with “×” and the normal active state data A2 is represented by the label with “◯” that indicates the normal active state. On the basis of the data identified by the label in this way, the two-dimensional space described above is divided into an area AR1 that includes the normal active state data A1 and areas AR2 and AR3 that include the accompanying time active state data A2 and defines boundary lines L1 and L2 of these areas. The learning unit 42 outputs these areas AR1, AR2, and AR3 and the boundary lines L1 and L2 to the compromise level measuring unit 43 as the learning result G2.

Furthermore, if the areas AR1, AR2, and AR3 and the boundary lines L1 and L2 are defined by the learning unit 42, by mapping newly acquired sensor data onto the divided space, it is possible to determine whether the new sensor data is obtained at the time of accompanying time active state or at the time of normal time active state. Namely, if a point P1 of the new step count data S1 on the object person A can be located in the area AR1 on the basis of the boundary lines L1 and L2, it can be determined that the point P1 indicates the normal active state and, if the point P1 can be located in the area AR2 or AR3 on the basis of the boundary lines L1 and L2, it can be determined that the point P1 indicates the accompanying time active state.

At this point, for example, if the learning unit 42 determines that the point P1 of the step count data S1 on the object person A focused at this time is located in the area AR2 that indicates the accompanying time active state, the compromise level measuring unit 43 calculates an Euclidean distance d2 from the point P1 to the boundary line L1, i.e., the perpendicular descending from the point P1 to the boundary line L1, as the compromise level J1 of the object person A and then outputs the calculation result to the relationship estimating unit 7. Furthermore, in a case in which the learning unit 42 determines that the point P1 representing the step count data S1 is located in the area AR3 that indicates the accompanying time active state, the learning unit 42 also calculates the compromise level J1 of the object person A by using the same method. Furthermore, in a similar manner as the above, the compromise level calculating unit 6 calculates the compromise level J2 of the object person B and then outputs the calculation result to the relationship estimating unit 7.

In the embodiment, in the unsupervised machine learning method or the supervised machine learning method, the Euclidean distance is used as the “distance” that represents the compromise level; however, the “distance” is not limited thereto. For example, the statistical distance, such as the Mahalanobis distance or the like, may also be used.

Furthermore, in the embodiment, in the unsupervised machine learning method or the supervised machine learning method, because the step count data is used as the sensor data that indicates the active state, a “step count per minute” and the “time” are used as the parameters that represent an active state. However, other than these, the active state may also be represented by a multidimensional space to which various parameters, such as a day of the week or weather, are added.

Furthermore, in the unsupervised machine learning method, instead of the distance between the center of gravity of each of the clusters C2 and C4, the difference between the average value of the step counts per minute indicated by the sensor data on the cluster C2 and the average value of the step counts per minute indicated by the sensor data on the cluster C4, the difference between the peak value of the step count per minute indicated by the sensor data on the cluster C2 and the peak value of the step count per minute indicated by the sensor data on the cluster C4, and the difference between the value of the standard deviation of the cluster C2 and the value of the standard deviation of the cluster C4 may also be calculated as the compromise level J1 of the object person A with respect to the object person B.

Relationship Estimating Unit

The relationship estimating unit 7 in the estimating unit 9 illustrated in FIG. 2 estimates, on the basis of the compromise levels J1 and J2 that are input from the compromise level calculating unit 6, the relationship between the focused object persons A and B and then outputs the estimated relationship to the relationship correcting unit 8 as a relationship estimation result Q1.

The “relationship” mentioned here is, for example, the organizational relationship or the connection of the personal human relationship. For example, it is assumed that the organizational relationship is the hierarchical relationship of a work responsibility, such as the object person A being a superior of the object person B and the object person B being a subordinate of the object person A. In such a relationship, there is the directional property in which the magnitude relation of the duty of the responsibility or a sense of respect of the object person B who is a subordinate is directed to the object person A.

Accordingly, the relationship estimating unit 7 compares the compromise level J1 of the object person A with the compromise level J2 of the object person B calculated by the compromise level calculating unit 6 and then determines that the object person with a greater level between the compromise levels J1 and J2 compromises greater than the other object person. For example, for the hierarchical relationship in a company organization, the relationship estimating unit 7 estimates the relationship between the object persons A and B, such as an object person with a greater compromise level being a subordinate and an object person with a smaller compromise level being a supervisor, and then defines the estimated result as the relationship estimation result Q1.

For example, if the assumption is given based on an example in which the compromise level J1 of the object person A described above is “10 steps/minute” and the compromise level J2 of the object person B is “30 steps/minute”, the compromise level J1 of the object person A is smaller than the compromise level J2 of the object person B. Consequently, the relationship estimating unit 7 obtains the relationship estimation result Q1 indicating that the object person A is a supervisor of the object person B and the object person B is a subordinate of the object person A.

In this way, a case in which, between the two object persons A and B, one of the object persons with a smaller level between the compromise levels J1 and J2 is defined as a supervisor of the other one of the object persons is only an example. The relationship based on the magnitude relationship between the compromise levels J1 and J2 can be defined by analyzing various cases. Depending on the result thereof, for example, the relationship estimating unit 7 may also defines, in contrast, that one of the object persons with a smaller level between the compromise levels J1 and J2 is a subordinate and the other one of the object persons with a greater level between the compromise levels J1 and J2 is a supervisor. In both cases, if there is a difference between the compromise levels J1 and J2 of the object persons A and B, respectively, it can be determined that the directional property is present in the relationship from one of the object persons toward the other one of the object persons.

Furthermore, if the compromise level J1 of the object person A and the compromise level J2 of the object person B are the same, the relationship estimating unit 7 can also acquires the relationship estimation result Q1 in which the relationship between the object persons A and B is colleagues, instead of the relationship between a supervisor and a subordinate.

Furthermore, by appropriately selecting the time range of the active state data that is acquired by the active state acquiring unit 5 and that is used for the calculation of a compromise level, the relationship between the object persons A and B described above can be estimated on the basis of, for example, the compromise levels J1 and J2 of the object persons A and B, respectively, obtained from the difference between the accompanying time active state at the time of the accompanying and the normal time active state at a time. Alternatively, the relationship between the object persons A and B can be finally determined on the basis-of the multiple compromise levels J1 and J2 of the object persons A and B, respectively, obtained from the difference between the multiple accompanying time active states and the multiple normal time active states at the time of accompanying.

In particular, in the latter case, if, for example, the relationship indicating that the object person A is a supervisor of the object person B is estimated four times and the relationship indicating that the object person B is a supervisor of the object person A is estimated once, the frequently estimated relationship result indicating that the object person A is a supervisor of the object person B can be defined as the final relationship estimation result Q1. Furthermore, if the relationship indicating that the object person A is a supervisor of the object person B is estimated three times and the relationship indicating that the object person B is a supervisor of the object person A is estimated three times, the estimated counts are the same; therefore, the relationship indicating that the “object person A and the object person B are colleagues” can also be defined as the final relationship estimation result Q1.

Furthermore, the relationship estimating unit 7 can takes into consideration the history of the past compromise levels J1 and J2 of the object persons A and B, respectively, as one of the factors when the relationship of the tendency indicating that it is easy to personally compromise between the object persons A and B (hereinafter, referred to as a first tendency) is estimated.

For example, the relationship estimating unit 7 refers to the history of the past compromise level J1 of the object person A. If the past compromise level J1 of the object person A is always “0 steps/minute”, i.e., there is no difference between the accompanying time active state and the normal time active state, the relationship estimating unit 7 identifies that the object person A has the first tendency indicating that it is difficult to compromise with the object person B.

In such a case, because the compromise level J1 of the object person A is “10 steps/minute” and the compromise level J2 of the object person B is “30 steps/minute”, the compromise level J2 of the object person B is greater than the compromise level J1 of the object person A. However, by considering the first tendency indicating that it is difficult for the object person A to compromise, the relationship estimating unit 7 can estimate the relationship indicating that the object person A is a subordinate of the object person B. If the first tendency has two types indicating that it is easy to compromise or it is difficult to compromise are present, the tendency information indicating such tendency is to be previously attached to the identification information on the object persons A and B.

Accordingly, if the tendency information on the first tendency indicating that it is difficult to compromise is attached to the identification information on the object person A and if no tendency information is attached to the identification information on the object person B, the relationship estimating unit 7 multiplies, for example, the weighting factor of “5” by “10 steps/minute” of the compromise level J1 of the object person A, thereby the relationship estimating unit 7 calculates the compromise level J1 of the object person A as “50 steps/minute” and compares the calculation result of “50 steps/minute” with “30 steps/minute” of the compromise level J2 of the object person B. Consequently, because the compromise level J1 of the object person A, which is obtained by multiplying the weighting-factor, is greater than the compromise level J2 of the object person B, the relationship estimating unit 7 can estimate the relationship indicating that the object person A is a subordinate of the object person B. Thus, the relationship estimating unit 7 can obtain the relationship estimation result Q1 in accordance with the tendency information on the object persons A and B.

Furthermore, the relationship estimating unit 7 takes into consideration the personal states of the object persons A and B as one of the factors when the relationship is estimated. An example of the personal state mentioned here includes a state in which an object person is in a hurry or not. In this case, the relationship estimating unit 7 acquires schedule data on the object persons A and B from the terminals carried by the object persons A and B or from a server and then refers to the terminals or the server. When the relationship estimating unit 7 detects that a schedule related to the object person A is present immediately after the accompanying, if the step count data S0 of the normal time active state data A2 on the object person A is “80 steps/minute” and even if the step count the object person A is increased, such as the step count data S1 of the accompanying time active state data A1 being “90 steps/minute”, the relationship estimating unit. 7 takes into consideration the personal state in which the object person A was originally in a hurry and thus multiplies, for example, the coefficient that is equal to or less than 1.0, such as “0.8” or the like, by the compromise level of “10 steps/minute”.

In contrast, if the step count data S0 of the normal time active state data A2 on the object person B is “120 steps/minute” and even if the step count is reduced, such as the step count data S2 of the accompanying time-active state data A1 being “90 steps/minute”, the relationship estimating unit 7 takes into consideration the personal state in which the object person B needed to reduce the step count even though the object person B was in a hurry but was not able to increase the step count due to the object person B accompanying the object person A and thus multiplies, for example, the coefficient that is equal to or greater than 1.0, such as “1.2” or the like, by the compromise level of “30 steps/minute”. Then, the compromise level J1 of the object person A becomes “8 steps/minute” and the compromise level J2 of the object person B becomes “36 steps/minute”.

Consequently, not only does the relationship estimating unit 7 estimate the relationship between the object persons A and B on the basis of the compromise level J1 of the object person A and the compromise level J2 of the object person B, but it also obtains the compromise levels J1 and J2 by taking into consideration as one of the factors when the relationship of the personal state between the object persons A and B is estimated. Then, the relationship estimating unit 7 can estimate the relationship between the object persons A and B on the basis of the obtained compromise levels J1 and J2, respectively, thus the accuracy of the relationship estimation result Q1 can be further improved in accordance with the personal state.

Furthermore, the relationship estimating unit 7 includes a relationship change estimating unit 7a, which will be described later, that estimates, in addition to estimating the relationship between the object persons A and B, a change in the relationship in time series. The relationship change estimating unit 7a takes into consideration a change in the compromise levels J1 and J2 of the object persons A and B, respectively, in time series as one of the factors when the relationship is estimated, estimates a change in the relationship of the object persons A and B, and outputs the result of the relationship change to the relationship correcting unit 8.

In this case, the relationship change estimating unit 7a monitors a change in the compromise levels J1 and J2 of the object persons A and B, respectively, in time series in a certain time period in the past. If the compromise level. J2 of the object person B is greater than the compromise level J1 of the object person A at first and, after that, if the compromise level J1 of the object person A becomes greater than the compromise level J2 of the object person B, the relationship change estimating unit 7a can also estimate the result of the relationship change of the object persons A and B indicating that the object person A is a supervisor of the object person B at first but, after that, the object person B becomes a supervisor of the object person A.

Specifically, the relationship change estimating unit 7a calculates the difference between the compromise levels J1 and J2 obtained when the object persons A and B are immediately previously accompanied and the compromise levels J1 and J2 obtained when the object persons A and B are accompanied this time. When the compromise level 31 of the object person A obtained when the object persons A and B were immediately previously accompanied was “10 steps/minute” and the compromise level J2 of the object person B obtained when the object persons A and B were accompanied this time was “30 steps/minute”, if the compromise level J1 of the object person A obtained when the object persons A and B are accompanied this time is “35 steps/minute” and the compromise level J2 of the object person B obtained when the object persons A and B are accompanied this time is “5 steps/minute”, the difference of the compromise level J1 of the object person A is “+25 steps/minute” and the difference of the compromise level J2 of the object person B is “−25 steps/minute”. Consequently, the compromise level J1 of the object person A becomes greater than the compromise level J2 of the object person B. Accordingly, the relationship estimating unit 7 can estimate that the relationship between the object persons A and B is inverted due to a change in time series.

As described above, the estimating unit 9, i.e., the compromise level calculating unit 6 and the relationship estimating unit 7, can estimate the relationship between the object persons A and B on the basis of the distance, i.e., the compromise levels J1 and J2, that is calculated from multiple pieces of active state data, i.e., the accompanying time active state data A1 and B1 and the normal time active state data A2 and B2, that is obtained in accordance with the accompanying state of the object persons A and B and can output the relationship estimation result Q1 to the relationship correcting unit 8.

Relationship Correcting Unit

The relationship correcting unit 8 illustrated in FIG. 2 corrects the relationship estimation result Q1 of the object persons A and B estimated by the relationship estimating unit 7 in the estimating unit 9, thereby relationship correcting unit 8 obtains a relationship estimation correction result Q1S by improving the accuracy of correcting the relationship estimation result Q1, outputs the obtained result to the displaying unit 3, and updates it as the final display content.

Specifically, the relationship correcting unit 8 refers to the step count data S1 and S2 before and after the object persons A and B are accompanied and checks whether the relationship estimation result Q1 between the object persons A and B is correct on the basis of active states, i.e., the step count information, of the object persons A and B obtained before and after the object persons A and B are accompanied. If it is determined that an error is present in the relationship estimation result Q1, the relationship correcting unit 8 obtains the relationship estimation correction result Q1S that is obtained by correcting the relationship between the object persons A and B.

For example, after the relationship estimation result Q1 indicating that the object person A is a supervisor and the object person B is a subordinate is obtained by the relationship estimating unit 7, if the relationship correcting unit 8 detects that the step count of the object person B obtained after the accompanying is reduced from that obtained before that accompanying, the relationship correcting unit 8 determines that the step count-obtained after the accompanying is reduced from the step count obtained before the accompanying because the object person B, who is a subordinate, becomes in a relaxed state due to a release of tension after the object person A has accompanied the object person B, who is a supervisor. In this case, the relationship correcting unit 8 determines that the relationship estimation result Q1 between the object persons A and B is correct and does not perform any correction on the relationship estimation result Q1.

Furthermore, after the relationship estimation result Q1 indicating that the object person A is a supervisor and the object person B is a subordinate is obtained by the relationship estimating unit 7, if the relationship correcting unit 8 detects that the step count of the object person A obtained after the accompanying is reduced from that obtained before that accompanying, as described above, it is assumed that the step count after the accompanying is reduced from the step count before, the accompanying due to a relaxed state of the object person A after a release of tension. Consequently, in this case, the relationship correcting unit 8 determines that there is a high possibility that the object person A is not a supervisor of the object person B but is a subordinate of the object person B. Then, the relationship correcting unit 8 corrects the relationship estimation result Q1 about the object persons A and B estimated by the relationship estimating unit 7 and then updates the relationship estimation result Q1 to the relationship estimation correction result Q1S indicating that the object person A is a subordinate and the object person B is a supervisor.

In this way, after the relationship correcting unit 8 obtains the relationship estimation result Q1 about the object persons A and B estimated by the relationship estimating unit 7, the relationship correcting unit 8 checks the reliability of the relationship estimation result Q1 on the basis of a change in the active state of the object persons A and B before and after the object persons A and B are accompanied. If it is determined that there is a high possibility that the relationship estimation result Q1 is incorrect, the relationship correcting unit 8 corrects the relationship estimation result Q1 and updates the result to the relationship estimation correction result Q1S.

Displaying Unit

The displaying unit 3 displays, on the basis of the relationship estimation result Q1 or the relationship estimation correction result Q1S supplied from the relationship correcting unit 8, the relationship between the object persons A and B on a monitor by using a directed graph such that the relationship can be visually and intuitively understood.

When, first, on the basis of the relationship estimation result Q1 or the relationship estimation correction result Q1S, the displaying unit 3 recognizes that the object persons A and B were accompanied, the displaying unit 3 displays a line segment that connects the icons of the object persons A and B. If the value of a relationship intensity information K1 calculated by the relationship level information calculating unit 24 in the accompanying detecting unit 4 exceeds a predetermined threshold, the displaying unit 3 displays the line segment connecting the icons of the object persons A and B by the thick line. If the value of the relationship intensity information K1 is equal to or less than the predetermined threshold, the displaying unit 3 displays the line segment connecting the icons of the object persons A and B by the thin line.

Then, on the basis of the relationship estimation result Q1 or the relationship estimation correction result Q1S obtained from the relationship estimating unit 7 and the relationship correcting unit 8, the displaying unit 3 attaches, while taking into consideration the relationship between the object persons A and B indicates the directional property, an arrow to the line segment connecting the icons of the object persons A and B in accordance with the directional property and then displays the relationship between the object persons A and B by using the arrow. For example, if the object person A is a supervisor of the object person B, the displaying unit 3 attaches an arrow to the line segment connecting the icons of the object persons A and B represented by “object person A←object person B”. If the object person A is a subordinate of the object person B, the displaying unit 3 attaches an arrow to the line segment connecting the icons of the object persons A and B represented by “object person A→object person B”.

When the relationship change estimating unit 7a in the relationship estimating unit 7 monitors a change in the compromise levels J1 and J2 of the object persons A and B, respectively, in time series, if the displaying unit 3 recognizes, as the result of the monitoring, that the object-person A was a supervisor of the object person B at first but, after that, the object person A becomes a subordinate of the object person B, the displaying unit 3 can display the relationship between the object persons A and B by representing “object person A4-object person B” by using an arrow by, for example, the broken line and representing “object person A→object person B” by using an arrow by, for example, the solid line.

Furthermore, if the relationship estimating unit 7 estimates that the relationship between the object persons A and B are colleagues, the displaying unit 3 can display between the object persons A and B by representing, for example, “object person A⇄object person B” by attaching two arrows to the line segment connecting the icons of the object persons A and B.

Operation of Relationship Estimation Device According to First Embodiment

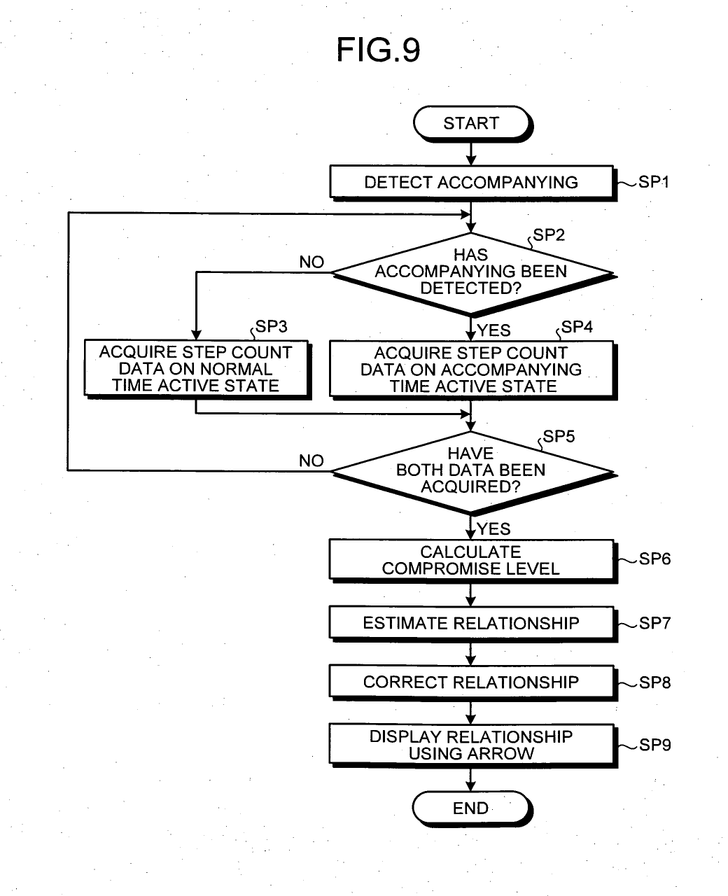

An operation of the relationship estimation device 1 having such a configuration will be described with reference to FIG. 9 by using a flowchart. The relationship estimation device 1 starts a-start step of a routine-RT1 and then subsequently proceeds to Step SP1. On the basis of the step count data S1 and S2 on the object persons A and B, respectively, that are currently focused by the accompanying detecting unit 4, the relationship estimation device 1 detects whether the object persons A and B are accompanied and then outputs the result indicating whether the object persons A and B are accompanied, the duration of the accompanying, and the relationship intensity information K1 about the object persons A and B to the active state acquiring unit 5 as the detection result obtained by the accompanying detecting unit 4.

At Step SP2, as the detection result obtained by the accompanying detecting unit 4 at Step SP1, the relationship estimation device 1 determines whether a state indicating that the object persons A and B are accompanied has been detected. If the relationship estimation device 1 obtains the detection result indicating that the object persons A and B are not accompanied from the non-accompanying determination result T2, the relationship estimation device 1 subsequently proceeds to Step SP3. If the relationship estimation device 1 obtains the detection result indicating that the object persons A and B are accompanied from the accompanying determination result T1, the relationship estimation device 1 subsequently proceeds to Step SP4.

At Step SP3, the relationship estimation device 1 acquires, from the active state acquiring unit 5, the normal time active state data A2 (step count data S0) on the object persons A and B obtained when the object persons A and B are not accompanied and then subsequently proceeds to Step SP5.

At Step SP4, the relationship estimation device 1 acquired, from the active state acquiring unit 5, accompanying time active state data A1 (step count data S1) on the object persons A and B obtained when the object persons A and B are accompanied and then subsequently proceeds to Step SP5.

At Step SP5, the relationship estimation device 1 determines whether both the normal time active state data A2 obtained when the object persons A and B are not accompanied and the accompanying time active state data A1 obtained when the object persons A and B are accompanied can be acquired. If both the data is not acquired, the relationship estimation device 1 returns to Step SP2 and then repeats the processes described above. If both the data is acquired, the relationship estimation device 1 subsequently proceeds to Step SP6.

At Step SP6, by using the unsupervised machine learning method, the supervised machine learning method, or the like performed by the compromise level calculating unit 6, the relationship estimation device 1 obtains the distances d1 and d2 between the object persons A and B related to each of the normal time active state data A2 and the accompanying time active state data A1, thereby calculating the compromise levels J1 and J2 of the object persons A and B, respectively.

At Step SP7, on the basis of the comparison result (large/small) of the compromise levels J1 and J2 of the object persons A and B, respectively, calculated by the compromise level calculating unit 6 in the estimating unit 9, the relationship estimation device 1 estimates, by using the relationship estimating unit 7, the relationship between the object persons A and B, thereby the relationship estimation device 1 obtains the relationship estimation result Q1 and subsequently proceeds to Step SP8.

At Step SP8, for the relationship estimation result Q1 of the object persons A and B estimated by the relationship estimating unit 7, the relationship estimation device 1 compares, by using the relationship correcting unit 8, the step count data obtained in the pre-accompanying active state with the step count data obtained in the post-accompanying active state that are obtained before and after, respectively, the object persons A and D are accompanied, the relationship estimation device 1 checks whether relationship estimation result Q1 of the object persons A and B is correct. If the relationship estimation device 1 determines that an error is present in the relationship estimation result Q1, the relationship estimation device 1 corrects, by using the relationship correcting unit 8, the relationship between the object persons A and B, outputs the relationship estimation correction result Q1S to the displaying-unit 3, and then subsequently proceeds to Step SP9. If the relationship estimation device 1 determines that no error is present in the relationship estimation result Q1, the relationship estimation device 1 outputs the relationship estimation result Q1 to the displaying unit 3 without performing any correction.

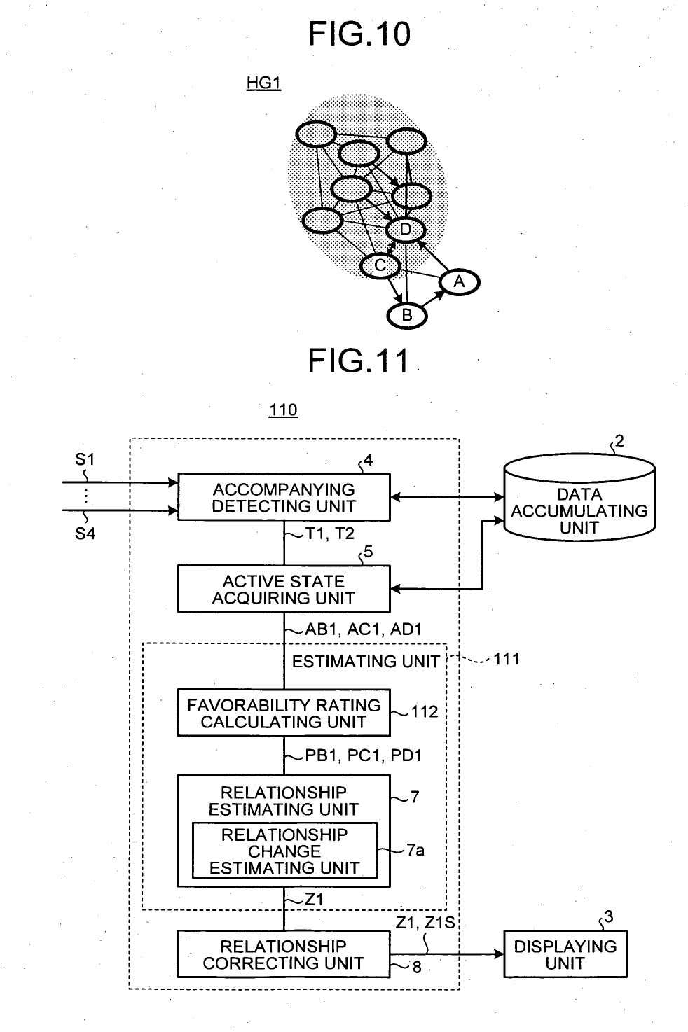

At Step SP9, for the relationship between the object persons A to D obtained on the basis of the relationship estimation result Q1 or the relationship estimation correction result Q1S obtained from the relationship estimating unit 7 and the relationship correcting unit 8, the relationship estimation device 1 displays, by using the displaying unit 3, a directed graph as a human relationship graph HG1 illustrated in FIG. 10 in which the line segments between the icons of the object persons A to D are indicated by arrows by using and then ends the series of the processed.

In this case, the circle represents the icon of each of the object persons A, B, C, and D. The thickness of the line segment between the icons of the object persons A, B, C, and D increases in proportion to the degree of the relationship between the object persons on the basis of the relationship intensity information K1. In this case, the line segment between object persons indicates whether the object persons are accompanied. The line segment is not indicated for the object persons who are not accompanied. In this case, for example, a case in which the object persons A and B were accompanied before and the object person A is a supervisor of the object person B is indicated by an arrow and a case in which the object persons A and B were accompanied before and the object person B is a supervisor of the object person C is indicated by an arrow.

Accordingly, the status indicating whether the object persons A, B, C, and D were accompanied or the degree of the relationship between the object persons displayed on the displaying unit 3 can be intuitively represented by depending on the thickness of the line segment between the icons of the object persons A, B, C, and D and, furthermore, the relationship between the object persons A, B, C, and D can also be intuitively represented by the arrow attached to a line segment between icons. Furthermore, if the object persons C and D are colleagues and have no hierarchical relationship in an organization, because the arrows are displayed between the icons of the object persons C and D, it is possible to instantaneously and intuitively understand that the relationship between the object persons C and D are colleagues.

As described above, the relationship estimation device 1 can estimate the relationship between the object persons A to D by using only the step count data S1 to S4 obtained from the sensors SE1 to SE4 carried by the object persons A to D, respectively, and can display the human relationship graph HG1 by which the relationship between the object persons A to D can be intuitively understood.

Overall Configuration of Relationship Estimation System According to Second Embodiment

By using sensor data (step count data) obtained from a sensor, such as a pedometer, carried by an object person targeted for the relationship estimation, a relationship estimation system according to a second embodiment obtains, the favorability rating as a second index with respect to the other object persons B to D when, for example, the focused object person A accompanies the other object persons B to D and then estimates, on the basis of the favorability rating, the favorable relationship between 1 to n, i.e., the object person A and the object persons B to D. Of course, in the relationship estimation system in the second embodiment, in addition to the object person A, it is also possible to estimate the favorable relationship between 1 to n, i.e., one of the focused object persons B, C, and D and the other object person other than the focused object person when they are accompanied.

As illustrated in FIG. 1, a relationship estimation system 200 according to the second embodiment will be described. The configuration of the relationship estimation system 200 according to the second embodiment differs from the relationship estimation system 100 according to the first embodiment in that, instead of the relationship estimation device 1, the relationship estimation device 111 that estimates the favorable relationship between object persons is used and the configuration of other components used in the second embodiment is the same as that in the first embodiment; therefore, descriptions thereof will be omitted.

Configuration of Relationship Estimation Device According to Second Embodiment

As illustrated in FIG. 11 by using the same reference numerals for the same components illustrated in FIG. 2, a relationship estimation device 110 includes an estimating unit 111, which is constituted by the accompanying detecting unit 4, the active state acquiring unit 5, a favorability rating calculating unit 112, and the relationship estimating unit 7. The favorability rating calculating unit 112 is provided instead of the compromise level calculating unit 6 in the estimating unit 9 according to the first embodiment.

On the basis of the step count data S1 to S4 received from the sensors SE1 to SE4, respectively, the accompanying detecting unit 4 in the relationship estimation device 110 detects the accompanying state of the object person A, who is the target for the calculation of the favorability rating, with respect to each of the object persons B to D and then outputs the accompanying determination result T1 or the non-accompanying determination result. T2 of each of the object persons B to D to the active state acquiring unit 5.

On the basis of the accompanying determination result T1 received from the accompanying detecting unit 4, the active state acquiring unit 5 acquires accompanying time active state data AB1, AC1, and AD1 on the object person A with respect to the object persons B to D, respectively, and then outputs the data to the favorability rating calculating unit 112 in the estimating unit 111.

The favorability rating calculating unit 112 in the estimating unit 111 is a unit that calculates favorability ratings PB1, PC1, and PD1 that are a second indices indicating how much the focused object person A has a good feeling or a disgusting feeling toward each of the other object persons B to D, i.e., has a positive feeling (positive polarity) or a negative feeling (negative polarity).

Specifically, the favorability rating calculating unit 112 compares the overall average value of the accompanying time active state data AB1, AC1, and AD1 on the object person A with respect to the object persons B to D (hereinafter, referred to as the “reference index”), respectively, supplied from the active state-acquiring unit 5 with the average value of the accompanying time active state data AB1 (hereinafter, referred to as the “object person index”), the average value of the accompanying time active state data AC1 (object person index), and the average value of the accompanying time active state data AD1 (object person index) indicating the object person A with respect to the multiple object persons B to D, respectively. Then, the favorability rating calculating unit 112 calculates the difference (distance) between the overall average value (reference index) of the accompanying time active state data AB1, AC1, and AD1 and the average value (object person index) of the accompanying time active state data AB1, AC1, and AD1 as the favorability ratings PB1, PC1, and PD1, respectively, as the second index and then outputs the results to the relationship estimating unit 7. In addition to the favorability ratings PB1, PC1, and PD1, the second index mentioned here also includes the “reference index” and the “object person index” that are used to calculate the favorability ratings PB1, PC1, and PD1.

On the basis of the favorability ratings PB1, PC1, and PD1 supplied from the favorability rating calculating unit 112, the relationship estimating unit 7 estimates the favorable relationship that indicates the positive feeling or the negative feeling from the object person A toward each of the object persons B to D and then outputs each of the estimated results to the displaying unit 3 as the favorable relationship estimation result Z1.

For example, if the difference (distance) between the overall average value (reference index) of the accompanying time active state data AB1, AC1, and AD1 and the average value (object person index) of the accompanying time active state data AB1 is the greatest, it can be conceivable that the object person A has the strongest positive feeling towards the object person D. Accordingly, when the object person A accompanies the object person D, the positive feeling of the object person A toward the object person D is to be included in the accompanying time active state data D1 that indicates the state when the object person A accompanies the object person D.

Thus, when the object person A accompanies the object person D, it is conceivable that the step count per minute is increased due to a high feeling of the object person A; therefore, the average value (object person index) of the accompanying time active state data AD1 on the object person A greatly exceeds the overall average value (reference index) of the accompanying time active state data AB1, AC1, and AD1 and the distance (favorability rating PD1) between the object person A and the object person D is the greatest value on the plus side (positive polarity). In such a case, the relationship estimating unit 7 estimates that the object person A has the highest favorability rating with respect to the object person D and then outputs the estimated result to the displaying unit 3 as the favorable relationship estimation result Z1.

Furthermore, if the average value (object person index) of the accompanying time active state data AD1 on the object person A falls below the overall average value (reference index) of the accompanying time active state data AB1, AC1, and AD and the distance (favorability rating PD1) between the object person A and the object person D is a value on the minus side (negative polarity), the relationship estimating unit 7 estimates that the object person A has a disgusting feeling, i.e., a negative feeling, toward the object person D because it is conceivable that the step count per minute is decreased due to a depressed feeling of the object person A when the object person A accompanies the object person D.

In contrast, if the object person A has the strongest positive feeling toward the object person D, it can also be conceivable that the step count per minute is decreased due to a feeling of the object person A that the object person A wants to stay with the object person D as long as possible when the object person A accompanies the object person D. In such a case, the average value of the accompanying time active state data AD1 on the object person A greatly falls below the overall average value of the accompanying time active state data AB1, AC1, and AD1 and the distance (favorability rating PD1) between the object person A and the object person D is the greatest value on the minus side; therefore, the relationship estimating unit 7 can also determine that the object person A has the highest favorability rating with respect to the object person D and output this determination result to the displaying unit 3 as the favorable relationship estimation result Z1.

Furthermore, in addition to the favorability rating PD1 of the object person A with respect to the object person D, the relationship estimating unit 7 can also calculate the favorability rating between the focused object person and the other object persons other than the focused object person, such as the favorability ratings PB1 and PC1 of the object person A with respect to the object persons B and C, respectively, or the favorability rating of the object person D with respect to the object person A, and can output the determination result in accordance with the favorability rating obtained from the calculation result to the displaying unit 3 as the favorable relationship estimation result Z1 of the object persons A to D.

As described above, the estimating unit 111, i.e., the favorability rating calculating unit 112 and the relationship estimating unit 7, can obtain, as the favorability ratings PB1, PC1, and PD1, the distance that is calculated on the basis of the reference index and the object person index obtained from multiple pieces of active state data (the accompanying time active state data AB1, AC1, and AD1) obtained in accordance with the accompanying state of the object person A with respect to each of the other object persons B to D; can estimate the favorable relationship between the object person A and each of the other object persons B to D on the basis of the associated favorability ratings PB1, PC1, and PD1; and can output the favorable relationship estimation result Z1 of the estimated result to the relationship correcting unit 8.

The favorable relationship estimation result Z1 mentioned here indicates, in the connection of the personal human relationship, the favorable relationship indicating, for example, that the object person A has a positive feeling toward the object person D. However, in addition to the directional property indicating that the object person A has a feeling toward the object person D, it is conceivable that the “polarity” of the directional property indicating that object person A has a positive feeling (positive polarity) or a negative feeling (negative polarity) toward the object person D is present in the favorable relationship estimation result Z1.

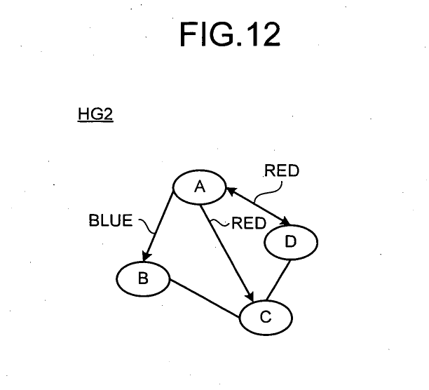

Accordingly, in accordance with the favorable relationship estimation result Z1 supplied from the relationship estimating unit 7, if the displaying unit 3 recognizes that, for example, the object person A has a positive feeling toward the object person D, the displaying unit 3 attaches an arrow illustrated in FIG. 12 to the line segment that connects the object persons A and D from the object person A to the object person D and displays a human relationship graph HG2 by using a directed graph in which the target arrow is represented by a red color (RED), which makes it possible to instantaneously and intuitively understand that the object person A has a positive feeling toward the object person D by using the arrow and a red color.

Furthermore, if the displaying unit 3 recognizes, for example, that the object person D has a positive feeling toward the object person A from the favorable relationship estimation result Z2, the displaying unit 3 displays the human relationship graph HG2 illustrated in FIG. 12 in which, in addition to the red arrow directed from the object person A toward the object person D, the arrow directed from the object person D toward the object person A in a red color (RED), which makes it possible to instantaneously and intuitively understand that the object persons A and D have good relationship with positive feelings with each other by using both the red arrows.

Furthermore, if the displaying unit 3 recognizes, for example, that the object person A has a negative feeling toward the object person B from the favorable relationship estimation result Z1 supplied from the relationship estimating unit 7, the displaying unit 3 attaches an arrow directed from the object person A to the object person B to the line segment that connects the object persons A and B and displays the human relationship graph HG2 illustrated in FIG. 12 by using the arrow in a blue color (BLUE), which makes it possible to instantaneously and intuitively understand that that the object person A has a negative feeling toward the object person B by using an arrow and a blue color.

In this case, the displaying unit 3 displays the positive feeling by using the red arrow and the negative feeling by using the blue arrow; however, the method is not limited thereto. For example, the positive feeling may also be represented by an arrow in a deep color, an arrow with the thick line, or an arrow with the solid line and the negative feeling may also be represented by an arrow in a pale color, an arrow with the thin line, or an arrow with the broken line. Furthermore, as the simplest displaying method, a positive feeling may also be represented by an arrow and a negative feeling may also be represented by an arrow with the symbol of “×”.

The relationship estimating unit 7 can take into consideration, as one of the factors used when the relationship is estimated, the tendency of a personal feeling (the polarity of a positive feeling or a negative feeling) of the focused object person A with respect to each of the other object persons B to D (hereinafter, referred to as a second tendency) obtained based on the past favorability ratings PB1, PC1, and PD1 of the focused object person A with respect to the other object persons B to D, respectively.

Even if the favorability rating PD1 obtained this time indicates a positive feeling, and if the favorability rating PD1 of the focused object person A toward the other object person D obtained in the past indicates the polarity of a negative feeling multiple times, the relationship estimating unit 7 takes into consideration the second tendency indicating that, for example, the object person A has a negative feeling toward the object person D in the past and can estimate the favorable relationship indicating that the object person A has a negative feeling toward the object person D.

The relationship change estimating unit 7a can take into consideration a change in the favorability ratings PB1, PC1, and PD1 of the focused object person A with respect to the other object persons B to D, respectively, in time series as one of the factors used when the relationship is estimated; can estimate a change in the relationship between the object person A and each of the object persons B to D; and can output the relationship change result to the relationship correcting unit 8.

In this case, the relationship change estimating unit 7a can monitor a change in the favorability ratings PB1, PC1, and PD1 in time series of the object person A with respect to the other object persons B to D, respectively, in a certain time period in the past and can also estimate the relationship change result of the object persons A and D, respectively, indicating that the object person A has a negative feeling toward the object person D at first, but, after that, the object person A has changed to have a positive feeling toward the object person D.

Furthermore, for the favorable relationship estimation result Z1 of the object persons A and D estimated by the relationship estimating unit 7, the relationship correcting unit 8 compares the step count data obtained in the pre-accompanying active state with the step count data obtained in the post-accompanying active state that are obtained before and after, respectively, the object persons A and D are accompanied and then checks whether the favorable relationship estimation result Z1 of the object persons A and D is correct. If it is determined that an error is present in the favorable relationship estimation result Z1, the relationship correcting unit 8 can correct the relationship between the object persons A and D and can output the correction result to the displaying unit 3 as the favorable relationship estimation correction result Z1S. However, if it is determined that no error is present in the favorable relationship estimation result Z1 that is obtained by the relationship estimating unit 7, the relationship correcting unit 8 outputs the favorable relationship estimation result Z1 to the displaying unit 3 without performing any correction.

### ANOTHER EMBODIMENT

In the first and the second embodiments described above, a description has been given of a case in which the relationship between the four object persons A to D is estimated; however, the present invention is not limited thereto. The relationship between greater number of object person may also be estimated.

Furthermore, in the first and the second embodiments described above, a description has been given of a case of estimating the organizational hierarchical relationship, such as the relationship between a supervisor and a subordinate, in an organization as the relationship between the object persons A and B or estimating the personal favorable relationship indicating that the object person A likes the object person B; however, the present invention is not limited thereto. Personal chemistry between object persons may also be estimated. For example, when chemistry of the object persons is indicated, it is estimated that the object persons have good chemistry if the compromise levels of the object persons are the same or similar and then two arrows may also be attached to on both ends of the line segment that connects the object persons.

Furthermore, in the first embodiment described above, a description has been given of a case in which the organizational hierarchical relationship between the object persons A to D is estimated and, in the second embodiment described above, a description has been given of a case in which the favorable relationship between the focused object person A and each of the multiple object persons B to D is estimated; however, the present invention is not limited thereto. Both the organizational hierarchical relationship and the favorable relationship may also be simultaneously estimated. In such a case, if a mode that is used to display the organizational hierarchical relationship is selected, the displaying unit 3 displays the human relationship graph HG1 that indicates the organizational hierarchical relationship and if, after that, a mode that is used to display the personal favorable relationship is selected, the displaying unit 3 displays the human relationship graph HG2 that indicates the personal favorable relationship on the basis of the organizational hierarchical relationship, which makes it possible to recognize both the organizational hierarchical relationship and the personal-favorable relationship between the focused object person A and each of the other object persons B to D.

Furthermore, in the first embodiment described above, a description has been given of a case in which the relationship between the object persons A to D is indicated by attaching an arrow to the line segment connecting the object persons; however, the present invention is not limited thereto. The relationship between the object persons A to D may also be indicated by using various display methods, such as the thickness of the line segment, dark and light coloring, the type of line used for the line segment (a solid line, a broken line, or the like), and the like.

Furthermore, in the first and the second embodiments described above, a description has been given of a case in which the relationship estimation devices 1 and 111 outputs the relationship estimation result Q1 or the favorable relationship estimation result Z1 to the external displaying unit 3 and thus indicates the relationship between the object persons A to D; however, the present invention is not limited thereto. Instead of externally arranging the displaying unit 3, the displaying unit 3 may also be integrally installed in the relationship estimation devices 1 and 111 as a single unit.

According to an embodiment, an advantage is provided in that the relationship between the object persons who are detected that the object persons are accompanied from sensor data acquired by a sensor.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A relationship estimation device comprising:
an accompanying detecting unit that detects, on the basis of sensor data acquired by a sensor carried by each of two or more object persons, an accompanying state in which the object persons behave together;
an active state acquiring unit that acquires, for each object person, multiple pieces of active state data each of which indicates an active state of each of the object persons and that are acquired in accordance with the accompanying state of the object persons detected by the accompanying detecting unit; and
an estimating unit that estimates, on the basis of the distances calculated from the multiple pieces of the active state data on the object persons, the relationship between the object persons.

2. The relationship estimation device according to claim 1, wherein
The active state acquiring unit acquires, for each object person, accompanying time active state data that indicates an active state of each of the object persons at the time of accompanying of the object persons and normal time active state data that indicates an active state of each of the object persons at a normal time at which the object persons are not accompanied that are obtained when the accompanying state of the object persons is detected by the accompanying detecting unit, and
the estimating unit includes
a first index calculating unit that calculates, for each object person on the basis of the distance calculated from the accompanying time active state data and the normal time active state data, a first index of the object persons, and
a relationship estimating unit that estimates the relationship between the object persons on the basis of the first index.

3. The relationship estimation device according to claim 1, wherein
the active state acquiring unit acquires, for each object person, accompanying time active state data that indicates an active state of each of the object persons at the time of accompanying of the object persons and that is obtained when the accompanying state of the object persons is detected by the accompanying detecting unit, and
the estimating unit includes a second index calculating unit that calculates,
on the basis of the distance, which is calculated from multiple pieces of the accompanying time active state data, between a focused object person and each of the multiple other object persons at the time of accompanying of the object persons, a second index of the focused object person with respect to the other multiple object persons, and
a relationship estimating unit that estimates, on the basis of the second index, the relationship between the object persons.

4. The relationship estimation device according to claim 2, wherein the estimating unit estimates a directional property in accordance with a comparison result of the first index for each object person as the relationship between the object persons.

5. The relationship estimation device according to claim 3, wherein
the estimating unit estimates the relationship between the object persons, as the relationship between the object persons, on the basis of a reference index that is used as the second index and that is used as a reference related to the focused object person and the multiple other object persons from whom the accompanying state has been detected and on the basis of an object person index used as the second index of the focused object person with respect to the multiple other object persons, and
the relationship is the directional property between the focused object person and the multiple other object persons and the polarity of the directional property.

6. The relationship estimation device according to claim 2, wherein the estimating unit recognizes the tendency of the object persons on the basis of the history of the first index or the second index of the object persons in the past and estimates the relationship between the object persons by taking into consideration of the tendency.

7. The relationship estimation device according to claim 2, wherein the estimating unit includes a relationship change estimating unit that observes, in time series, the history of the first index or the second index of the object persons in the past and that estimates a change in the relationship between the object persons.

8. The relationship estimation device according to claim 1, further comprising a relationship correcting unit that corrects the relationship between the object persons on the basis of a change in the sensor data that is obtained before and after the accompanying state of the object persons is detected by the accompanying detecting unit.

9. A relationship estimation method comprising:
detecting, by an accompanying detecting unit on the basis of sensor data acquired by a sensor carried by each of two or more object persons, an accompanying state of the object persons;
acquiring, by an active state acquiring unit for each object person, multiple pieces of active state data each of which indicates an active state of each of the object persons and that are acquired in accordance with the accompanying state of the object persons detected at the detecting; and
estimating, by an estimating unit, on the basis of the distances calculated from the multiple pieces of the active state data on the object persons, the relationship between the object persons.

10. A computer-readable recording medium having stored therein a program causing a computer to execute a process comprising:
detecting, on the basis of sensor data acquired by a sensor carried by each of two or more object persons, an accompanying state of the object persons;
acquiring, for each object person, multiple pieces of active state data each of which indicates an active state of each of the object persons and that are acquired in accordance with the accompanying state of the object persons detected at the detecting; and
estimating, on the basis of the distances calculated from the multiple pieces of the active state data on the object persons, the relationship between the object persons.
